(19) United States
(12) Patent Application Publication
(10) Pub. No.: US 2006/0262986 A1
(43) Pub. Date: Nov. 23, 2006

(54) System and method for compressing a document image

(75) Inventor: Hyung-soo Ohk, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd,

(21) Appl. No.: 11/389,168

(22) Filed: Mar. 27, 2006

(30) Foreign Application Priority Data
May 20, 2005 (KR) 2005-0042396

(51) Int. Cl. G06K 9/46; G06K 9/54

(52) U.S. Cl. 382/243; 382/302; 382/173

(57) ABSTRACT

Provided is a system and method for compressing a document image including a mask decomposer for unitizing each symbol, while decomposing the mask, according to a brightness change of a text character constituting the mask, if symbol unit compression is to be performed, wherein the mask comprises an area based on positions of characters decomposed from a document image; and a mask encoder for compressing the mask by using a repetition of each symbol decomposed from the mask decomposer. By the above constructions, symbols are prevented from connecting when generating the mask such that the number of symbols can decrease and symbols can be more easily matched.

### CROSS-REFERENCE TO RELATED PATENT APPLICATION

This application claims the benefit under 35 U.S.C. § 119(a) of Korean Patent Application No. 2005-42396 filed on May 20, 2005, in the Korean Intellectual Property Office, the entire disclosure of which is hereby incorporated by reference.

### BACKGROUND OF THE INVENTION

1. Field of the Invention

The present invention relates to a system and method for compressing a document image. More particularly, the present invention relates to a system and method for compressing a document which can reduce the number of symbols and allow for easier symbol matching by preventing each symbol from connecting to each other when generating a mask.

2. Description of the Related Art

The Mixed Raster Contents (MRC) compression scheme is standardized by ITU T.44. In operation, it applies different encoding schemes for text and picture data that is received as combined data. Generally, text and picture data has different properties. Pixel position information is important for text data whereas pixel color information is important for picture data. Therefore, if a same compression scheme is applied to both text and picture data, image quality may be deteriorated. To prevent the deterioration, a 1 bit compression scheme may be used for text data, and a jpeg/jp2k scheme may be used for picture data. Examples of a 1 bit compression scheme include a modified reed (MR), a modified Huffman coding (MH), a modified MR (MMR), a joint bi-level image experts group (JBIG), and a JBIG2 compression scheme. MR, MH, MMR, and JBIG are non-symbol matching schemes that simplify groups of bits according to repetition of 0 and 1 bits in order to compress them, and JBIG2 is a symbol matching scheme that removes repetitive text characters from text data so as to compress the text data.

As shown in FIG. 1, the MRC compression scheme, according to the above principles, decomposes an input image into a background layer, a foreground layer, and a mask layer. In the MRC compression scheme a different codec is applied to each layer in order to compress the input image.

As shown in FIG. 2, a compression system for implementing the conventional MRC compression scheme comprises a mask decomposer 2, a foreground and background decomposer 5, a mask encoder 6, a background encoder 10, a foreground encoder 8, and a combination part 12.

The mask decomposer 2 decomposes the document image into the mask layer and the foreground/background decomposer 5 decomposes the document image into the background layer and the foreground layer. The background layer, the foreground layer, and mask layer decomposed from the document image are respectively transmitted to the background encoder 10, the foreground encoder 8, and the mask encoder 6 to be compressed according to an appropriate compression scheme. Each compressed background, foreground and mask are combined in the combination part 12 to be output.

To compress the mask according to the conventional MRC compression system, the 1 bit compression scheme is used. Recently, JBIG2 has become increasingly used.

The compression process of the mask layer by using JBIG2 will be explained below. Text data is decomposed into symbol units, by separating pixels corresponding to an edge of the pixel group layer and pixels corresponding to an inside of the pixel group layer. By using conventional methods, pixel values for individual pixels and neighboring pixels are compared in order to separate the pixels corresponding to the edge and the inside.

If text data is decomposed into a symbol unit according to the above method, as an image is input as shown in FIG. 3, the mask layer is extracted as shown in FIG. 4. Text data of the extracted mask layer is decomposed into a symbol unit. As the text is output via a printer or scanner, ‘c’ and ‘a’, and ‘e’ and ‘s’ are connected as shown in the square portions of FIG. 4. In other words, according to the conventional mask decomposition scheme, ‘c’ and ‘a’ are connected to be symbolized as ‘ca’, and ‘e’ and ‘s’ are symbolized as ‘es’. If ‘c’, ‘a’, ‘e’, ‘s’ are independently symbolized, they may be referred to easily during the compression process, whereas if ‘ca’ and ‘es’ are symbolized, they may not be referred to during the compression process. Accordingly, as the number of symbols increases it becomes increasingly difficult to match symbols.

As such, when a mask is extracted that has a compressed mask layer according to the JBIG2 compression scheme, it is necessary to separate connected characters when symbolizing so that the number of symbols can be decreased and so that symbols can be more efficiently matched.

Accordingly, there is a need for an improved system and method for compressing a document which can decrease the number of symbols when extracting a mask and more easily matches symbols.

### SUMMARY OF THE INVENTION

Exemplary embodiments of the present invention address at least the above problems and/or disadvantages and provide at least the advantages described below. Accordingly, an aspect of an exemplary embodiment of the present invention is to provide a system and method for compressing a document which can decrease the number of symbols when extracting a mask and more easily match symbols.

According to an aspect of an exemplary embodiment of the present invention, a system for compressing a document comprises a mask decomposer for unitizing each symbol, while decomposing the mask, according to a brightness change of a text character constituting the mask, if symbol unit compression is to be performed, wherein the mask comprises an area based on positions of characters decomposed from a document image; and a mask encoder for compressing the mask by using a repetition of each symbol decomposed from the mask decomposer.

The system further comprises a mask compression selection part for selecting whether the document image is to be compressed using symbol unit compression, wherein the mask decomposer unitizes each symbol to extract the mask according to a selection from the mask compression selection part.

The mask decomposer may sense the brightness change per line based on a pixel unit of each symbol to decompose the symbol if the brightness change is more than a certain degree and is repeated more than a certain number of times.

The mask decomposer may sense the brightness change per line based on a pixel unit of each symbol to decompose the symbol if the brightness value is maintained for more than a certain section at an intermediate level.

The mask decomposer may generates the mask by increasing a threshold for extracting the mask by a certain degree so as to be greater than a brightness value of a connection area of the neighboring symbols.

According to another aspect of an exemplary embodiment of the present invention, a method for compressing a document comprises selecting if a mask is to be compressed using symbol unit compression, the mask comprising an area based on positions of characters decomposed from a document image; if the mask is selected to be compressed using symbol unit compression, unitizing each symbol according to a brightness change of a text character constituting the mask while decomposing the mask; and compressing the mask by using a repetition of each decomposed symbol.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain embodiments of the present invention will be more apparent from the following description taken in conjunction with the accompanying drawings, in which:

FIG. 1 is a conceptual view of Mixed Raster Contents (MRC) compression system;

FIG. 2 is a block diagram of the MRC compression system of FIG. 1;

FIG. 3 is a view of a original text of a document image for the MRC compression system of FIG. 2;

FIG. 4 is a view of a mask decomposed from the document image of FIG. 3 by the mask decomposer;

FIG. 5 is a block diagram of the MRC compression system according to an exemplary embodiment of the present invention;

FIG. 6A is a graph of an ideal brightness change of a mask;

FIG. 6B is a graph of an actual brightness change of a mask; and

FIG. 7 is a view of a mask generated by the mask decomposer according to an exemplary embodiment of the present invention.

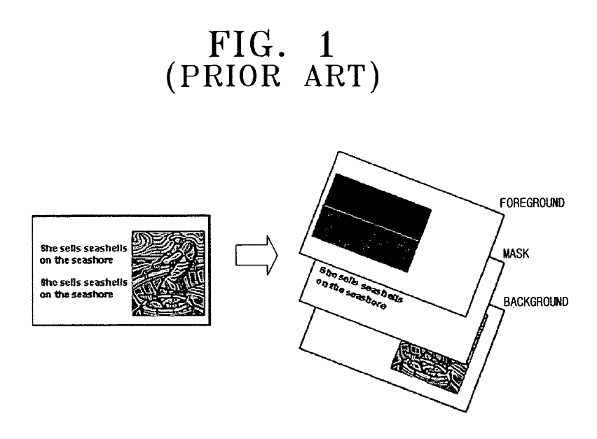

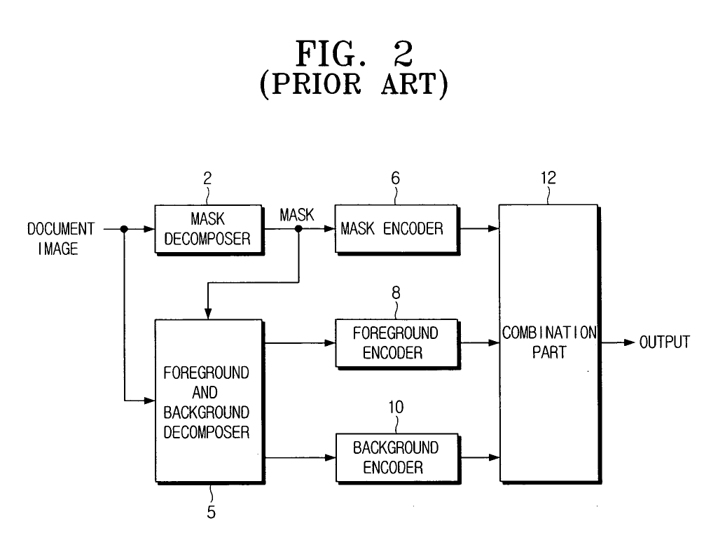

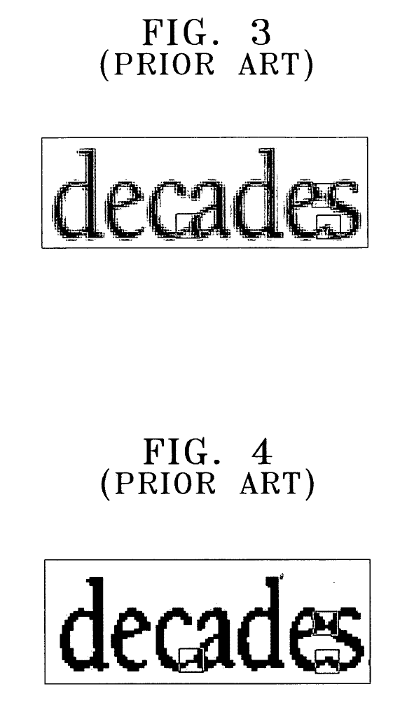

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention and are merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

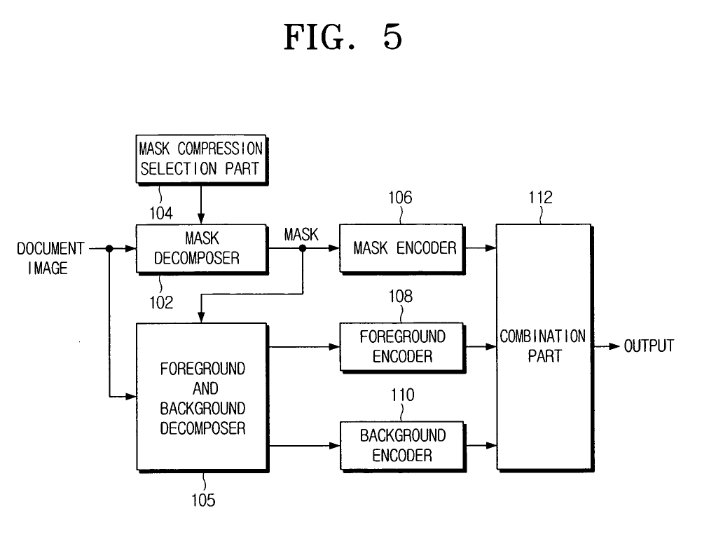

FIG. 5 is a block diagram of the MRC compression system according to an exemplary embodiment of the present invention. The MRC compressing system comprises a mask compression selection part 104, a mask decomposer 102, a foreground and background decomposer 105, a mask encoder 106, a background encoder 110, a foreground encoder 108, and a combination part 112.

The mask compression selection part 104 provides the mask decomposer 102 with a compression method that is selected by a user or that has been set in advance. To compress the mask, a non-symbol matching may be used which simplifies groups of bits according to a repetition of 0 and 1 bits. In the alternative, a symbol matching may be used which removes repetitive symbols.

The mask compression selection part 104 provides the mask decomposer 102 with information on one of the MR, MH, MMR and JBIG non-symbol matching methods or the JBIG2 symbol matching method. When the mask compression selection part 104 selects JBIG2, the mask decomposer 102 extracts the mask such that it is suitable for the symbol compression method.

The mask decomposer 102 extracts a mask, based upon character positions in the input document image, according to the compression method selected by the mask compression selection part 104. The mask decomposer 102 provides the mask encoder 106 and the foreground and background decomposer 105 with the mask. The mask decomposer 102 processes the mask so that symbol unit compression can be performed using the decomposed mask, when a symbol unit compression method such as JBIG2 is selected by the mask compression selection part 104. The mask decomposer 102 decomposes the document image into two layers, that is, a mask layer and the foreground and background layer. The mask is a binary image, and a pixel value in the mask depends on whether the pixel belongs to the foreground layer or background layer.

The mask decomposer 102 extracts the mask by using the brightness change of the decomposed mask. If a mask is decomposed according to a conventional mask decomposer, it may have inter-symbol interference caused by the process of printing and scanning, and therefore, ‘c’ and ‘a’, and ‘e’ and ‘s’ may be connected as shown in FIG. 4. As such, the mask decomposer 102 according to an exemplary embodiment of the present invention removes the connection of the neighboring symbols with reference to the brightness change of each line for each pixel of the mask.

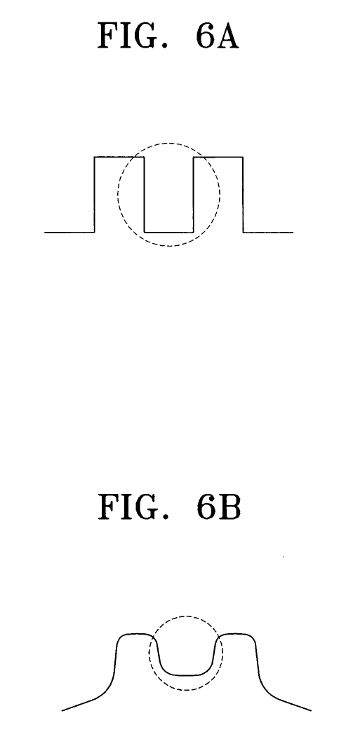

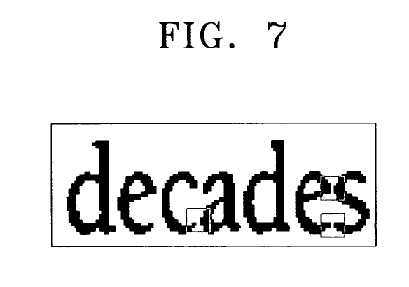

Under ideal conditions, a mask should be expressed as a square wave having a brightness difference between a blank and a line portion of symbol and there should be greater than a certain distance between line portions of the symbol, as shown in FIG. 6A. In FIG. 6A, the blank portion is bright and the line portion of symbol is dark. However, as a result of the process of printing and scanning, the brightness change of the mask becomes minimal between the blank and the line portions of the symbol, and thus is not expressed as an exact square wave, as shown in FIG. 6B. Additionally, the areas connecting ‘c’ and ‘a’, and ‘e’ and ‘s’ are brightened from the dark area, but not completely. In other words, the connecting areas re-darken. Accordingly, an area with a brightness of an intermediate tone occurs as shown in a circled portion of FIG. 6B. The mask decomposer 102 checks the number of portions that brightens and re-darkens, or darkens and re-brightens, and may determine the neighboring symbols are connected if the number of portions is greater than a certain number or if a portion with an intermediate brightness exists. As such, if it is determined that there exists neighboring symbols connected to each other, the mask decomposer 102 filters the relevant portions so that the portions are decomposed into separate symbols, so that the mask can be output as shown in FIG. 7. The mask decomposer 102 may increase a threshold for forming the whole mask and filter the portions with the intermediate brightness tones so that each symbol can be prevented from connecting.

The foreground and background decomposer 105 receives the input document image and the mask from the mask decomposer 102. By using the mask, the foreground and background decomposer 105 decomposes the document image into the foreground layer and background layer. Individual pixels of the document image are allocated to the foreground layer or the background layer according to whether the pixels match the pixels of the mask. For example, if the value of pixel matching the mask is ‘1’, the pixel may be allocated to the foreground layer, and if the value of pixel matching the mask is ‘0’, the pixel may be allocated to the background layer. Alternatively, if the value of the pixel matching the mask is ‘1’, the pixel may be allocated to the background layer, and if the value of the pixel matching the mask is ‘0’, the pixel may be allocated to the foreground layer.

The mask encoder 106 receives the mask from the mask decomposer 102 to compress the mask with a bit unit. The mask encoder 106 may use various compression methods, as selected from the mask compression selection part 104, when compressing the mask into a binary form with text information. Preferably, the mask encoder 106, uses the JBIG2 symbol matching method. If JBIG2 is applied, the mask encoder 106 extracts each portion of text in a symbol unit from the mask. At this time, the mask is formed so as to be decomposed into each symbol unit from the mask decomposer 102, and therefore, individual ‘d’, ‘e’, ‘c’, ‘a’, ‘d’, ‘e’ and ‘s’ are extracted. The ‘d’ and ‘e’ are repeated twice, respectively, and therefore, they can be compressed.

The foreground encoder 108 receives a foreground image from the foreground and background decomposer 105 to encode the foreground image into a foreground bit stream.

The background encoder 110 receives a background image from the foreground and background decomposer 105 to encode the background image into a background bit stream.

The combination part 112 receives the compressed bit streams, respectively, from the mask encoder 106, foreground encoder 108 and background encoder 110 to combine the bit stream into an output stream or an output file. The combination part 112 may allow the output stream or the output file to have a header including identification information such as compression type.

The document image compression process in the MRC compression system according to the above constructions will be explained hereinafter.

If a document image is input, the document image is transmitted to the mask decomposer 102 and the foreground and background decomposer 105, respectively. The mask compression selection part 104 provides the mask decomposer 102 with information on the method to compress the mask as set by a user or set in advance. If the mask is compressed according to symbol matching, the mask decomposer 102 decomposes the mask into two layers and prevents neighboring symbols from connecting by using the brightness change per line of the decomposed mask.

The mask processed from the mask decomposer 102 is transmitted to the mask encoder 106 and the foreground and background decomposer 105, respectively. The mask encoder 106 compresses the mask into a bit stream according to a symbol unit, and the foreground and background decomposer 105 decomposes the foreground image and the background image of the document image using the mask. The decomposed foreground image and background image are transmitted to the foreground encoder 108 and the background encoder 110, respectively, and compressed into the foreground bit stream and the background bit stream, respectively.

The mask bit stream, the foreground bit stream, the background bit stream from the mask encoder 106, the foreground encoder 108, the background encoder 110, respectively, are transmitted to the combination part 112. The combination part 112 combines the bit streams to generate a single output stream or output file.

As described above, if the MRC compression system is applied according to an exemplary embodiment of the present invention, each symbol can be decomposed by using the brightness change per line of each text when generating a mask such that the connection between the neighboring symbols due to printing or scanning process can be prevented during the extracting of a mask. Therefore, the number of symbols is prevented from increasing and symbol matching can be more easily performed when compressing a mask according to JBIG2.

As described above, if the embodiments of the present invention are applied, the symbols are prevented from connecting when a mask is generated such that the number of symbols can increase and the symbol matching can be more easily performed.

While the invention has been shown and described with reference to certain embodiments thereof, it will be understood by those skilled in the art that various changes in form and details may be made therein without departing from the spirit and scope of the invention as defined by the appended claims.

What is claimed is:

1. A system for compressing a document image comprising:
a mask decomposer for unitizing each symbol, while decomposing the mask, according to a brightness change of a text character constituting the mask, if symbol unit compression is to be performed, wherein the mask comprises an area based on positions of characters decomposed from a document image; and
a mask encoder for compressing the mask by using a repetition of each symbol decomposed from the mask decomposer.

2. The system as claimed in claim 1, further comprising:
a mask compression selection part for selecting whether the document image is to be compressed using symbol unit compression,
wherein the mask decomposer unitizes each symbol to extract the mask according to a selection from the mask compression selection part.

3. The system as claimed in claim 1, wherein the mask decomposer senses the brightness change per line based on a pixel unit of each symbol to decompose the symbol if the brightness change is more than a certain degree and is repeated more than a certain number of times.

4. The system as claimed in claim 1, wherein the mask decomposer senses the brightness change per line based on a pixel unit of each symbol to decompose the symbol if the brightness value is maintained for more than a certain section at an intermediate level.

5. The system as claimed in claim 1, wherein the mask decomposer generates the mask by increasing a threshold for extracting the mask by a certain degree so as to be greater than a brightness value of a connection area of the neighboring symbols.

6. A method for compressing a document image comprising:
selecting if a mask is to be compressed using symbol unit compression, the mask comprising an area based on positions of characters decomposed from a document image;
if the mask is selected to be compressed using symbol unit compression, unitizing each symbol according to a brightness change of a text character constituting the mask while decomposing the mask; and
compressing the mask by using a repetition of each decomposed symbol.

7. The method as claimed in claim 6, wherein unitizing the symbol comprises sensing the brightness change per line based on a pixel unit of each symbol to unitize the symbol if the brightness change is more than a certain number of times.

8. The method as claimed in claim 1, wherein unitizing the symbol comprises sensing the brightness change per line based on a pixel unit of the text position to unitize the symbol if the brightness value is greater than a certain degree at an intermediate level.

9. The method as claimed in claim 6, wherein unitizing the symbol comprises generating the mask by increasing a threshold for extracting the mask by a certain degree to be greater than a brightness value of a connection area of neighboring symbols.
